(19) United States
(12) Patent Application Publication
(10) Pub. No.: US 2015/0269231 A1
(43) Pub. Date: Sep. 24, 2015

(54) CLUSTERED SEARCH RESULTS

(71) Applicants: David Francois Huynh, San Francisco, CA (US); Qianhao Qiu, Shanghai (CN)

(72) Inventors: David Francois Huynh, San Francisco, CA (US); Qianhao Qiu, Shanghai (CN)

(73) Assignee: Google Inc., Mountain Veiw, CA (US)

(21) Appl. No.: 14/420,195

(22) PCT Filed: Aug. 8, 2012
(86) PCT No.: PCT/CN2012/079797

§ 371 Date: May 8, 2015

(51) Int. Cl. G06F 17/30

(52) U.S. Cl. CPC G06F 17/30554; G06F 17/30864; G06F 17/30339; G06F 17/30244; G06F 17/30781

(57) ABSTRACT

Methods, systems, and computer readable media are provided for organizing search results. In some implementations, a search system receives a search query. In some implementations, the search system generates one or more second search queries based on the first search query and data stored in a data structure such as a knowledge graph. In some implementations, the search system causes search results to be generated based on the second search query, and causes the generated search results to be presented. In some implementations, the search system organizes the search results based on the second search queries.

### BACKGROUND

The present disclosure relates to a search system. Typically, search results are presented using a standard technique such as a list of text links. Conventional techniques for organizing search results include popularity or alphabetic sorting.

### SUMMARY

Methods, systems, and computer-readable media are provided for presenting search results.

In some implementations, a computer implemented method for presenting search results is provided. The method comprises determining an entity from a first search query. The method comprises identifying data associated with the entity, the data comprising an organizing property, wherein the data is derived from a knowledge graph, and wherein the data is associated with one or more types in the knowledge graph. The method comprises generating a second search query based on the organizing property. The method comprises causing search results to be generated based on the second search query. The method comprises causing to be presented the search results in an arrangement according to the organizing property.

In some implementations, a system for presenting search results is provided. The system comprises a database comprising a knowledge graph. The system comprises one or more computers configured to perform operations. The operations comprise determining an entity reference from a first search query. The operations comprise identifying data associated with the entity reference, the data comprising an organizing property, wherein the data is derived from the knowledge graph, and wherein the data is associated with one or more types in the knowledge graph. The operations comprise generating a second search query based on the organizing property. The operations comprise causing search results to be generated based on the second search query. The operations comprise causing to be presented the search results in an arrangement according to the organizing property.

In some implementations, a non-transitory computer-readable medium for use in presenting search results, the computer-readable medium having computer program instructions recorded thereon, is provided. Computer program instructions comprise determining an entity reference from a first search query. Computer program instructions comprise identifying data associated with the entity reference, the data comprising an organizing property, wherein the data is derived from a knowledge graph, and wherein the data is associated with one or more types in the knowledge graph. Computer program instructions comprise generating a second search query based on the organizing property. Computer program instructions comprise causing search results to be generated based on the second search query. Computer program instructions comprise causing to be presented the search results in an arrangement according to the organizing property.

In some implementations, a computer implemented method for organizing search results is provided. The method comprises traversing a knowledge graph to identify entity types, and to identify properties associated with each identified entity type. The method comprises organizing, for each identified entity type, the properties associated with the respective entity type based on at least one organizing criterion into organized properties. The method comprises storing the organized properties in a data structure that is usable to arrange search results based on the organized properties.

In some implementations, a system for presenting search results is provided. The system comprises a database comprising a knowledge graph. The system comprises one or more computers configured to perform operations. Operations comprise traversing the knowledge graph to identify entity types, and to identify properties associated with each identified entity type. Operations comprise, for each identified type, organizing the properties associated with the respective entity type based on at least one organizing criterion into organized properties. Operations comprise storing the organized properties in a data structure that is usable to arrange search results based on the organized properties.

In some implementations, a non-transitory computer-readable medium for use in search, the computer-readable medium having computer program instructions recorded thereon, is provided. Instructions comprise traversing a knowledge graph to identify entity types, and to identify properties associated with each identified entity type. Instructions comprise for each identified entity type, organizing, using one or more computers, the properties associated with the respective entity type based on at least one organizing criterion into organized properties. Instructions comprise storing the organized properties in a data structure that is usable to arrange search results based on the organized properties.

### BRIEF DESCRIPTION OF THE FIGURES

FIG. 1 shows an information flow diagram in accordance with some implementations of the present disclosure;

FIG. 2 shows an example user interface with rows of links in accordance with some implementations of the present disclosure;

FIG. 3 shows another example user interface with rows of links in accordance with some implementations of the present disclosure;

FIG. 4 shows an example user interface with columns of links in accordance with some implementations of the present disclosure;

FIG. 5 shows an illustrative knowledge graph portion containing nodes and edges in accordance with some implementations of the present disclosure;

FIG. 6 shows an illustrative knowledge graph portion in accordance with some implementations of the present disclosure;

FIG. 7 shows an illustrative knowledge graph portion in accordance with some implementations of the present disclosure;

FIG. 8 shows a flow diagram including illustrative steps for presenting search results in accordance with some implementations of the present disclosure;

FIG. 9 shows a flow diagram including illustrative steps for determining organizing properties in accordance with some implementations of the present disclosure;

FIG. 10 shows an illustrative computer system that may be used to implement some or all features of the search system in accordance with some implementations of the present disclosure; and

FIG. 11 shows a diagram of a user device in accordance with some implementations of the present disclosure.

### DETAILED DESCRIPTION OF THE FIGURES

In some implementations, a search system may retrieve search results based on a search query received from a user. While search results may be presented in a list, it may be desirable to organize and present the results based on their content, in order to provide relevant results. For example, where search results include images of dogs, it may be desirable to organize them by breed. In some implementations, a search system analyzes the content of a search query and/or search results, generates additional related search queries, and organizes the presented results based in part on those additional queries. In some implementations, a search system relies on data stored in a data structure to generate additional queries and organize the results.

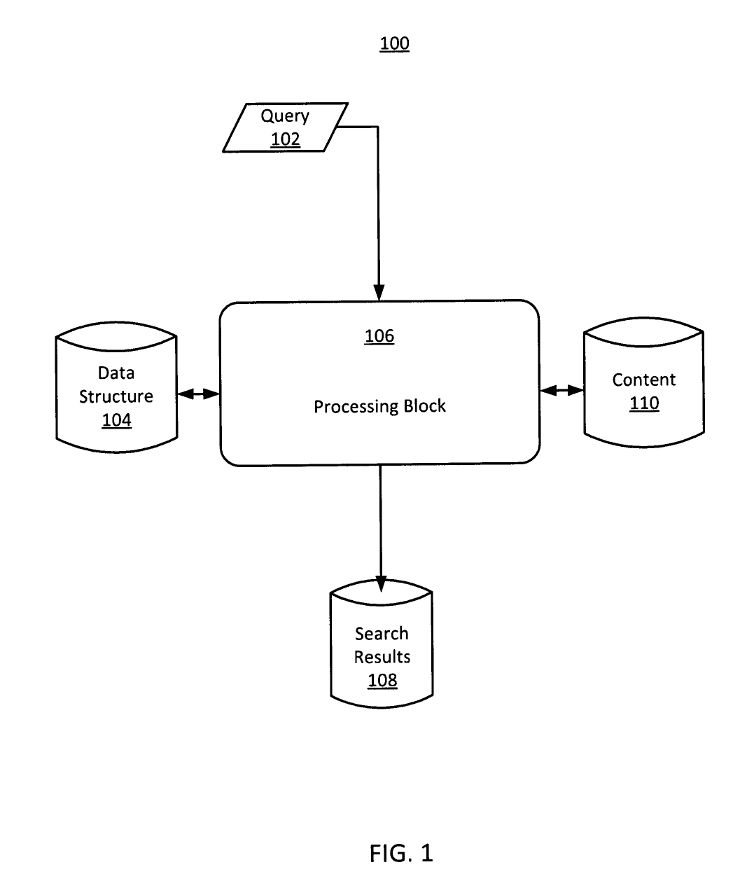

The following description and accompanying FIGS. 1-11 provide additional details and features of some implementations of the search system and its underlying system.

FIG. 1 shows information flow diagram 100 in accordance with some implementations of the present disclosure. Information flow diagram 100 includes processing block 106, query block 102, data structure block 104, content block 110, and search results block 108. In some implementations, the search system uses information from data structure block 104, content block 110, other sources not shown, or any combination thereof, to generate an output to search results block 108, based on a query received in query block 102.

Query block 102 includes a search query provided to processing block 106. In some implementations, the search query is a query received from a user. In some implementations, search queries are directed towards internet searches, text searches, image searches, database searches, searches of any other suitable index or collection of content, or any combination thereof. In some implementations, search queries are received from other applications, for example, a calendar program or web browser, from any other suitable source, or any combination thereof. For example, a search query may include data received from a calendar application. In some implementations, a search query may be used to query data structure block 104 and/or content block 110. In some implementations, the search query is text-based, image-based, audio-based, of any other suitable format, or any combination thereof. In an example, the search query is a text-based search for webpages. In another example, the search query is an image-based search for images.

In some implementations, search results related to the search query are retrieved by processing block 106 from data structure block 104, from content block 110, from any other suitable source, or any combination thereof. In some implementations, additional information is retrieved from data structure block 104. For example, additional retrieved data may be used by processing block 106 to generate additional related search queries. Search results for the additional queries may be retrieved, as above, from data structure block 104, from content block 110, from any other suitable source, or any combination thereof. In some implementations, the generating of second search queries and retrieving of search results is performed based in part on data stored in data structure 104.

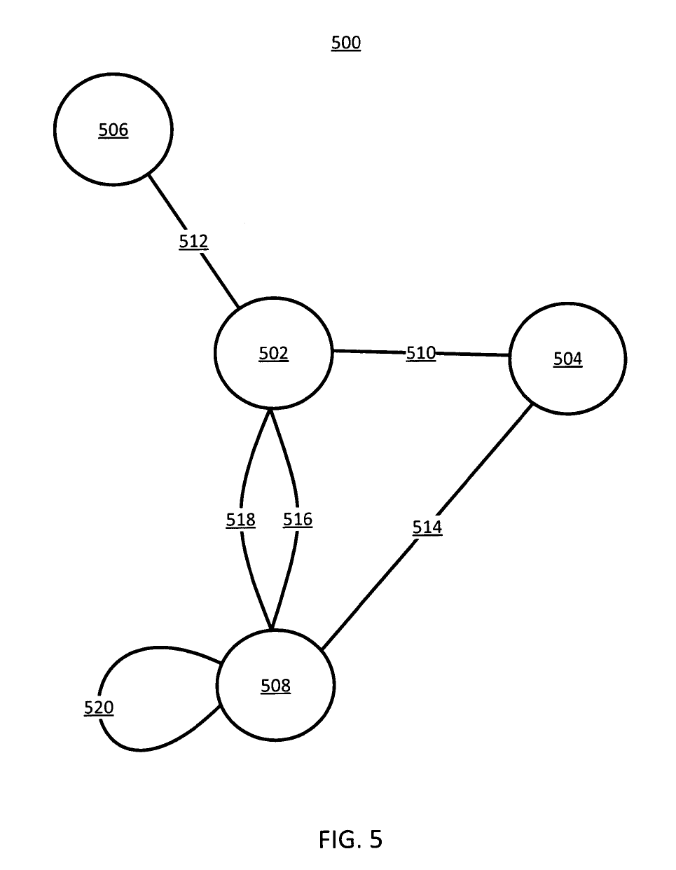

Data structure block 104 includes a data structure containing structured or otherwise organized, information. In some implementations, search results are retrieved from data structure block 104. In some implementations, metrics are determined based on data stored in data structure block 104. In some implementations, data structure block 104 contains a data graph, a database, an index, any other suitable collection of content, or any combination thereof. In an example, data structure block 104 includes a collection of data stored as nodes and edges in a graph structure. In some implementations, data structure block 104 includes a knowledge graph. In some implementations, a knowledge graph includes data organized in a graph containing nodes and edges. The data of a knowledge graph may include states about relationships between things and concepts, and those statements may be represented as nodes and edges of a graph. The nodes of a knowledge graph each contain a piece or pieces of data and the edges represent relationships between the data contained in the nodes that the edges connect. A particular implementation of a knowledge graph, is described below in FIGS. 5-7.

Content block 110 includes web sites and suitable other content. In an example, content block 110 includes webpages and other content on the internet containing text, images, videos, links, other suitable data, or any combination thereof. In some implementations, content block 110 includes information from a database, private intranet, public network, private network, any other suitable collection of information, or any combination thereof.

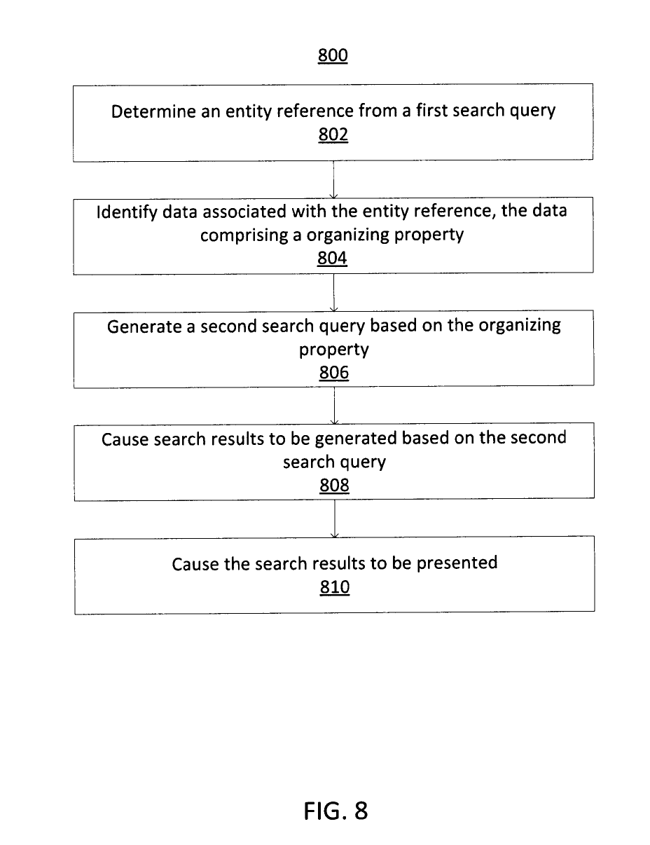

Processing block 106 includes processing steps for organizing, e.g., clustering, search results. Details of the processing steps are discussed below in reference to FIG. 8. In some implementations, the search system determines an entity reference included in the search query received from query block 102. As used herein, an entity is a thing or concept that is singular, unique, well-defined and distinguishable. For example, an entity may be a person, place, item, idea, topic, abstract concept, concrete element, other suitable thing, or any combination thereof. As used herein, an entity reference is an identifier, e.g., text, or other information that refers to an entity. For example, an entity may be the physical embodiment of George Washington, while an entity reference is an abstract concept that refers to George Washington. Where appropriate, based on context, it will be understood that the term entity as used herein may correspond to an entity reference, and the term entity reference as used herein may correspond to an entity.

In some implementations, processing block 106 includes an index, list, table, or other suitable data determined based on the content of content block 110. In an example, processing block 106 includes an index of webpages from content block 110.

In some implementations, the search system identifies data in data structure block 104 associated with the entity reference in the search query. In some implementations, the search system uses the data from data structure block 104 to generate one or more second search queries that are related to the first search query. In some implementations, results generated by the second search query are subsets of the original search results, related to the original search results, or any combination thereof.

Search results block 108 includes the output of processing block 106. In some implementations, search results block 108 includes text search results, image search results, audio search results, video search results, links to webpages, information from webpages, data retrieved from data structure block 104, any other suitable content, or any combination thereof. In some implementations, search results in search results block 108 are clustered or otherwise organized, based on the processing of processing block 106. In some implementations, search results are presented based on their relevance. In some implementations, data from search results block 108 is presented to a user using, for example, a display screen or a speaker.

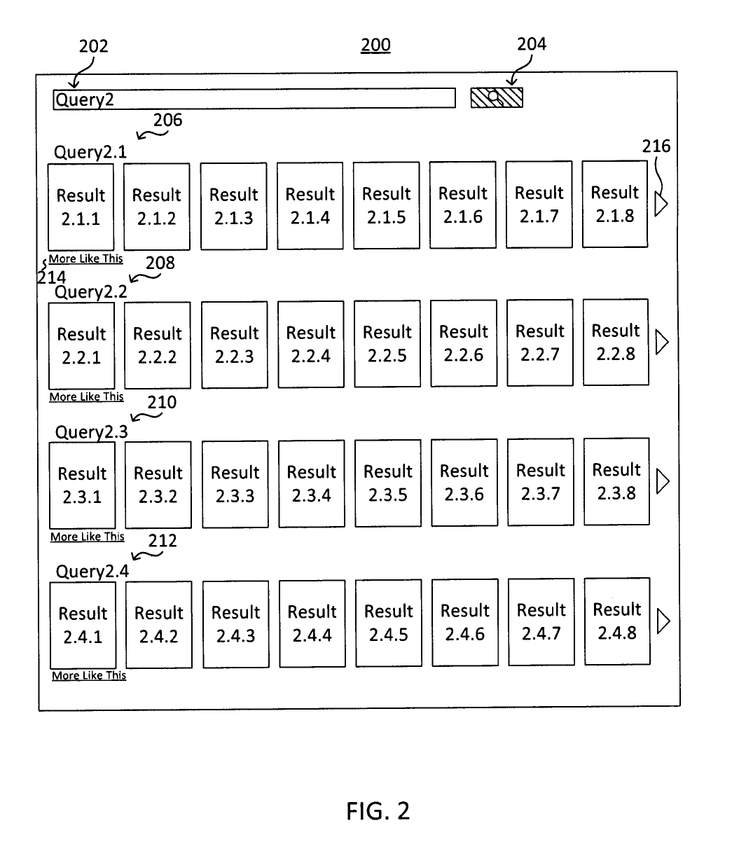

The following description and accompanying FIGS. 2-4 show illustrative user interfaces that may be used in some implementations of the present disclosure. In some implementations, the search results of search results block 108 of FIG. 1 are presented using the user interfaces that follow. In some implementations, these user interfaces illustrate clustered or otherwise organized, sets of related search results, such as those generated by processing block 106 of FIG. 1. It will be understood that these interfaces are merely examples and that content may be presented in any suitable technique. For example, search results may be presented horizontally, vertically, in a grid, in a scrollable window, in any other suitable technique, or any combination thereof. Search results may include text, images, video, links, any other suitable content, or any combination thereof. User interfaces may include any suitable elements not shown. In some implementations, presentation techniques may include visual techniques, audio techniques, any other suitable techniques, or any combination thereof.

FIG. 2 shows example user interface 200 with rows of links in accordance with some implementations of the present disclosure.

The user interface may include search query box 202. Search query box 202 may receive a textual search query, for example, as illustrated “Query2.” In some implementations, search query box 202 may receive an image as a search query, for example by a drag-and-drop action, may receive an audio search input from a file, may receive an textual input using a voice command and text-to-speech processing equipment, may receive input by any other suitable technique, or any combination thereof. Search button 204 may receive input triggering a search. For example, after receiving a textual search query in search query box 202, the system may receive input using search button 204 triggering a search. Input may include, for example, a mouse click, an indication of an area of a touchscreen, any other suitable input, or any combination thereof. In some implementations, a keyboard keystroke, such as the “enter key” may trigger a search.

In some implementations, the system may generate one or more second search queries based on the search query received in search query box 202. In some implementations, the search query received in search query box 202 corresponds to data in query block 102 of FIG. 1. For example, queries may include user input of text, user input of images, data from another application such as a calendar or web browser, data generated based on an action such as opening an email or particular webpage, any other suitable data, or any combination thereof. In the illustrated example, the search system receives the search query “Query2” in search query box 202. In some implementations, the search determines an entity reference included in “Query2.” In some implementations, the search system identifies data associated with the entity reference. In some implementations, the data is stored in a data structure such as data structure block 104 of FIG. 1. In some implementations, the data includes a schema table, or other suitable lists and tables of properties associated with the entity reference. In some implementations, a schema table is a collection of data that describes the properties associated with a type or category of entity reference. In some implementations, the search system selects an organizing property from the schema table. In some implementations, the system generates one or more second search queries based on the organizing property. In some implementations, the second search queries include terms from the first search query. In an example, “Query2” may be “Movies” and the organizing property may be genre. The search system may generate “Query2.1” as “Movies Horror,” Query as “Movies Comedy,” and “Query2.3” and “Movies Romance.” In some implementations, the search term from “Query2,” e.g., “Movies,” is omitted from the second search queries. In some implementations, titles for the second search queries may be displayed as “Query2.1” 206, “Query2.2” 208, “Query2.3” 210, and “Query2.4” 212. In some implementations, the search system may rank or otherwise order, “Query2.1” 206, “Query2.2” 208, Query2.3″ 210, and “Query2.4” 212 based on popularity and/or relevance data, an alphabetical value, a numerical value, a value stored in a data structure, a property stored in a data structure, any other suitable information, or any combination thereof. For example, where the second search queries are a variety of dog breeds, the second search queries may be ordered alphabetically. In a further example, the dog breeds may be ordered based on relevance and/or popularity data that is based, for example, on global search history. In another example, where the first search query “Query2” is “Skyscrapers,” and the organizing property is “Location,” the second search queries may include queries such as “Skyscrapers New York” and “Skyscrapers Dubai,” including results related to the Empire State Building and the Burj Khalifa, respectively. In another example, where the first search query “Query2” is “Skyscrapers,” and the organizing property is “Name,” the second search queries may include queries such as “Skyscraper Empire State Building,” “Skyscraper Burj Khalifa,” and “Skyscraper Petronas Tower,” where the Empire State Building, Burj Khalifa, and Petronas Tower are examples of skyscrapers. In another example, the search system may use more than one organizing property, resulting in the queries “Skyscraper Burj Khalifa,” “Skyscraper Petronas Tower,” “Skyscraper New York City,” and “Skyscraper Chicago” being used together. In some implementations, the heights of the buildings may be stored in the data structure and that data may be used to order the search queries.

In some implementations, the sets of search results associated with each second search query are displayed in rows. In some implementations, the search results include textual results, image results, video results, audio results, any other suitable results, or any combination thereof. In some implementations, search results include thumbnail images. As used herein, a thumbnail may include a resized, rescaled, cropped, or otherwise altered representation of another image or other content. For example, a thumbnail image may be a small version of a large image file. In some implementations, the search results include links to additional information such as webpages. In an example, the illustrated second search query “Query2.1” 206 is associated with search results “Result2.1.1,” “Result2.1.2,” “Result2.1.3,” “Result2.1.4,” “Result2.1.5,” “Result2.1.6,” “Result2.1.7,” and “Result2.1.8.” The illustrated second search query “Query2.2” 208 is associated with search results “Result2.2.1,” “Result2.2.2,” “Result2.2.3,” “Result2.2.4,” “Result2.2.5,” “Result2.2.6,” “Result2.2.7,” and “Result2.2.8.” The illustrated second search query “Query2.3” 210 is associated with search results “Result2.3.1,” “Result2.3.2,” “Result2.3.3,” “Result2.3.4,” “Result2.3.5,” “Result2.3.6,” “Result2.3.7,” and “Result2.3.8.” The illustrated second search query “Query2.4” 212 is associated with search results “Result2.4.1,” “Result2.4.2,” “Result2.4.3,” “Result2.4.4,” “Result2.4.5,” “Result2.4.6,” “Result2.4.7,” and “Result2.4.8.” Where the search results are image and/or video search results, the display may include thumbnails and/or rescaled versions of the image and/or video. In some implementations, the search system may receive input indicating a selection of a particular search result.

The associated search results for each respective second search query may be ordered using any suitable technique. For example, the search results may be ordered using relevance and/or popularity data. In some implementations, the highest ordered search may be the furthest to the left on the screen.

In some implementations, the search system may receive user input using a “More Like This” link 214. Selection of the link may indicate to the search system that the user desires more search results related to the associated second search query. In some implementations, the search system may remove the other second search queries from the display and show more results from the selected second search query.

In some implementations, the search system may include arrow 216. The search system may receive input related to a selection of arrow 216 and in response scroll and/or shift the selection of displayed search results. For example, where the search system includes a search results “Result2.1.9” but it is not displayed on the screen, receiving a selection of arrow 216 may cause “Result2.1.1” to be removed from the display, each of the search results shifted one space to the left, and “Result2.1.9” displayed in the location previously occupied by “Result2.1.8.”

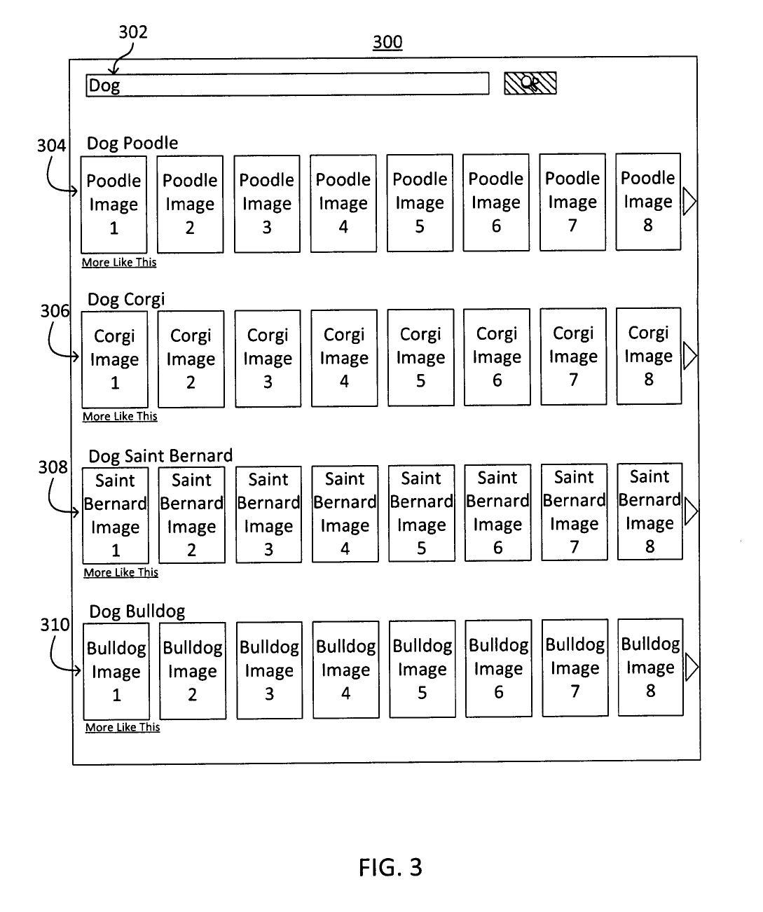

FIG. 3 shows example user interface 300 with rows of links in accordance with some implementations of the present disclosure. In some implementations, user interface 300 illustrates a particular example of the general implementation illustrated by user interface 200 of FIG. 2. In the example, user interface 300 displays image search results based on the received search query “Dog.”

In some implementations, search query box 302 receives search query “Dog” as described for search query box 202 of FIG. 2. In some implementations, the search system identifies the entity reference “Dog” in a data structure such as data structure block 104 of FIG. 1. In some implementations, the search system retrieves a schema table associated with the entity reference “Dog.” For example, the schema table may include the properties: “Breed,” “Color,” “Size,” and “Coat Length.” In some implementations, the search system may identify “Breed” as an organizing property. This may be identified based on predetermined parameters, user input, global search history, any other suitable parameters, or any combination thereof. In some implementations, the search system generates second search queries based on the received search query “Dog” and the organizing property “Breed.” In some implementations, the search system retrieves entity references associated with the property “Breed,” for example, “Poodle,” “Corgi,” “Saint Bernard,” and “Bulldog.” In some implementations, associated entity references may be retrieved from data structure block 104 of FIG. 1. In some implementations, the search system generates second search queries using these associated entity references, and retrieves search results using the second search queries. In some implementations, search results are retrieved from a search of the internet, from a data structure such as data structure block 104 of FIG. 1, from any other suitable index and/or database, or any combination thereof. Second search query 304 includes the query “Dog Poodle” and displays eight image search results. In some implementations, the image search results are thumbnail images that may receive a selection to display the source of the image, a larger version of the image, a webpage associated with the image, any other suitable content, or any combination thereof. Second search query 306 includes similar content for the search query “Dog Corgi.” Second search query 308 includes similar content for the search query “Dog Saint Bernard.” Second search query 310 includes similar content for the search query “Dog Bulldog.”

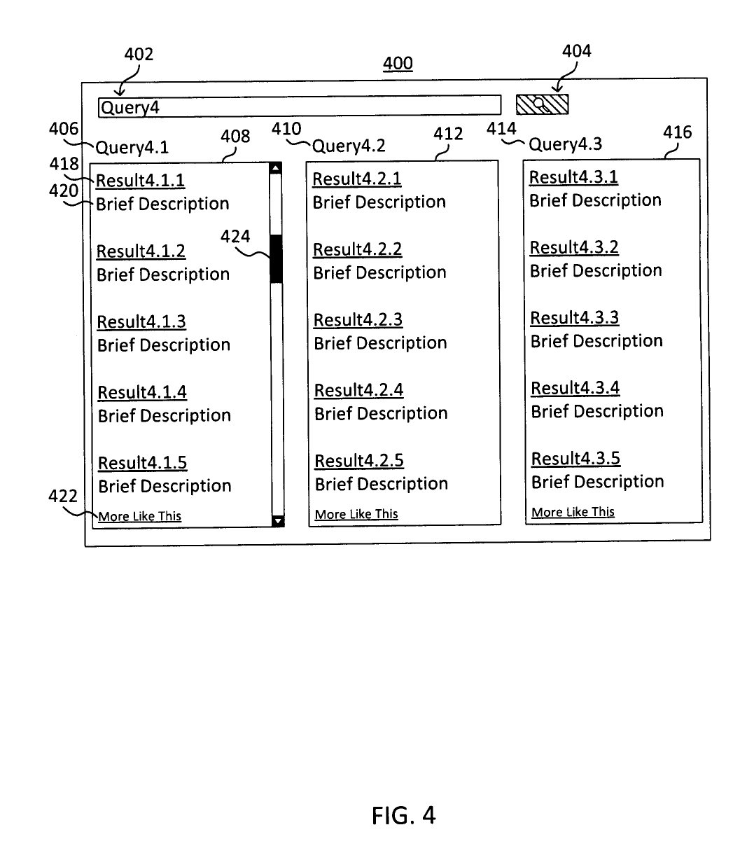

FIG. 4 shows example user interface 400 with columns of links in accordance with some implementations of the present disclosure.

The user interface may include a search query box 402. Search query box 402 may receive a textual search query, for example, as illustrated “Query4.” In some implementations, search query box 402 may be configured as described for search query box 202 of FIG. 2. In some implementations, search button 404 may be configured as described for search button 204 of FIG. 2.

In some implementations, one or more second search queries may be generated based on the first search query and an organizing property as described above for user interface 200 of FIG. 2. The second search results may include textual search results of a collection of information, for example, the Internet. The search system may display second search query “Query4.1” 406, “Query4.2” 410, and “Query4.3” 414 as columns along with associated search results. Search result box 408 associated with second search query “Query4.1” 406 includes search result link “Result4.1.1” 418, and brief description 420 of “Result4.1.1” 418. Search result box 408 associated with “Query4.1” 406 also includes “Result4.1.2,” “Result4.1.3,” “Result4.1.4,” and “Result4.1.5” Similarly, search result box 412 associated with second search query “Query4.2” 410 includes “Result4.2.1,” “Result4.2.2,” “Result4.2.3,” “Result4.2.4,” “Result4.2.5,” and corresponding brief descriptions. Similarly, search result box 416 associated with second search query “Query4.3” 414 includes “Result4.3.1,” “Result4.3.2,” “Result4.3.3,” “Result4.3.4,” “Result4.3.5,” and corresponding brief descriptions.

In some implementations, search result box 408 includes “More Like This” link 422. In some implementations, “More Like This” link 422 is configured as described for “More Like This” link 214 of FIG. 2. The search system may, in response to receiving a selection of “More Like This” link 422, remove the second search queries from the screen and show only results related to “Query4.1” 408. In some implementations, the search system may generate more second search queries related to “Query4.1” 408. In some implementations, the search system may retrieve more search results related to “Query4.1” 408. In some implementations, the system may receive input to scroll bar 424 indicating a desire to move the contents of search result box 408 up or down in search result box 408. In some implementations, scroll bar 424 may be configured similarly to arrow 216 of FIG. 2. It will be understood that the aforementioned is merely an example and that the system may reconfigured search results using any suitable technique.

The following description and accompanying FIGS. 5-7 described an illustrative knowledge graph that may be used with some implementations of the present disclosure. It will be understood that the knowledge graph is merely an example of a data structure that may be used by the search system, and that any suitable data structure may be used.

In some implementations, data may be organized in a database using any one or more data structuring techniques. For example, data may be organized in a graph containing nodes connected by edges. In some implementations, the data may include statements about relationships between things and concepts, and those statements may be represented as nodes and edges of a graph. The nodes each contain a piece or pieces of data and the edges represent relationships between the data contained in the nodes that the edges connect. In some implementations, the graph includes one or more pairs of nodes connected by an edge. In some implementations, the edge, and thus the graph, may be directed, undirected, or both. In an example, directed edges form a unidirectional connection. In an example, undirected edges form bidirectional connections. In an example, a combination of both directed and undirected edges may be included in the same graph. Nodes may include any suitable data or data representation. Edges may describe any suitable relationships between the data. In some implementations, an edge is labeled or annotated, such that it includes both the connection between the nodes, and descriptive information about that connection. A particular node may be connected by distinct edges to one or more other nodes, or to itself, such that an extended graph is formed. For purposes of clarity, a graph based on the structure described immediately above is referred to herein as a knowledge graph. In some implementations, the knowledge graph may be a useful for representing information and in providing information in search.

FIG. 5 shows illustrative knowledge graph 500 containing nodes and edges. Illustrative knowledge graph 500 includes nodes 502, 504, 506, and 508. Knowledge graph 500 includes edge 510 connecting node 502 and node 504. Knowledge graph 500 includes edge 512 connecting node 502 and node 506. Knowledge graph 500 includes edge 514 connecting node 504 and node 508. Knowledge graph 500 includes edge 516 and edge 518 connecting node 502 and node 508. Knowledge graph 500 includes edge 520 connecting node 508 to itself. Each aforementioned group of an edge and one or two distinct nodes may be referred to as a triple or 3-tuple. As illustrated, node 502 is directly connected by edges to three other nodes, while nodes 504 and 508 are directly connected by edges to two other nodes. Node 506 is connected by an edge to only one other node, and in some implementations, node 506 is referred to as a terminal node. As illustrated, nodes 502 and 508 are connected by two edges, indicating that the relationship between the nodes is defined by more than one property. As illustrated, node 508 is connected by edge 520 to itself, indicating that a node may relate to itself. While illustrative knowledge graph 500 contains edges that are not labeled as directional, it will be understood that each edge may be unidirectional or bidirectional. It will be understood that this example of a graph is merely an example and that any suitable size or arrangement of nodes and edges may be employed.

Generally, nodes in a knowledge graph can be grouped into several categories. Nodes may represent entity references, organizational data such as entity types and properties, literal values, and models of relationships between other nodes.

In some implementations, entity references, entity types, properties, and other suitable content is created, defined, redefined, altered, or otherwise generated by any suitable technique. For example, content may be generated by manual user input, by automatic responses to user interactions, by importation of data from external sources, by any other suitable technique, or any combination thereof. For example, if a commonly searched for term is not represented in the knowledge graph, one or more nodes representing that node may be added. In another example, a user may manually add information and organizational structures.

A node of a knowledge graph may represent an entity. An entity is a thing or concept that is singular, unique, well-defined and distinguishable. For example, an entity may be a person, place, item, idea, abstract concept, concrete element, other suitable thing, or any combination thereof. It will be understood that in some implementations, the knowledge graph contains an entity reference, and not the physical embodiment of the entity. For example, an entity may be the physical embodiment of George Washington, while an entity reference is an abstract concept that refers to George Washington. In another example, the entity “New York City” refers to the physical city, and the knowledge graph uses a concept of the physical city as represented by, for example, an element in a data structure, the name of the entity, any other suitable element, or any combination thereof. Where appropriate, based on context, it will be understood that the term entity as used herein may correspond to an entity reference, and the term entity reference as used herein may correspond to an entity.

Nodes are unique, in that no two nodes refer to the same thing or concept. Generally, entities include things or concepts represented linguistically by nouns. For example, the color “Blue,” the city “San Francisco,” and the imaginary animal “Unicorn” may each be entities. An entity reference generally refers to the concept of the entity. For example, the entity reference “New York City” refers to the physical city, and the knowledge graph uses a concept of the physical city as represented by, for example, an element in a data structure, the name of the entity, any other suitable element, or any combination thereof.

A node representing organizational data may be included in a knowledge graph. These may be referred to herein as entity type nodes. As used herein, an entity type node may refer to a node in a knowledge graph, while an entity type may refer to the concept represented by an entity type node. An entity type may be a defining characteristic of an entity. For example, entity type node Y may be connected to an entity reference node X by an “Is A” edge or link, discussed further below, such that the graph represents the information “The Entity X Is Type Y.” For example, the entity reference node “George Washington” may be connected to the entity type node “President.” An entity reference node may be connected to multiple entity type nodes, for example, “George Washington” may also be connected to entity type node “Person” and to entity type node “Military Commander.” In another example, the entity type node “City” may be connected to entity reference nodes “New York City” and “San Francisco.” In another example, the concept “Tall People,” although incompletely defined, e.g., the knowledge graph does not necessarily include a definition of “tall”, may exist as an entity type node. In some implementations, the presence of the entity type node “Tall People,” and other entity type nodes, may be based on user interaction.

In some implementations, an entity type node may include or be connected to data about: a list of properties associated with that entity type node, the domain to which that entity type node belongs, descriptions, values, any other suitable information, or any combination thereof. A domain refers to a collection of related entity types. For example, the domain “Film” may include, for example, the entity types “Actor,” “Director,” “Filming Location,” “Movie,” any other suitable entity type, or any combination thereof. In some implementations, entity references are associated with types in more than one domain. For example, the entity reference node “Benjamin Franklin” may be connected with the entity type node “Politician” in the domain “Government” as well as the entity type node “Inventor” in the domain “Business”.

In some implementations, properties associated with entity reference nodes or entity type nodes may also be represented as nodes. For example, nodes representing the property “Population” or “Location” may be connected to the entity type node “City.” The combination and/or arrangement of an entity type and its properties is referred to as a schema. In some implementations, schemas are stored in tables or other suitable data structures associated with an entity type node. In some implementations, the knowledge graph may be self-defining or bootstrapping, such that it includes particular nodes and edges that define the concept of nodes, edges, and the graph itself. For example, the knowledge graph may contain an entity reference node “Knowledge Graph” that is connected to property nodes that describe a knowledge graph's properties such as “Has Nodes” and “Has Edges.”

Specific values, in some implementations referred to as literals, may be associated with a particular entity reference in a terminal node by an edge defining the relationship. Literals may refer to values and/or strings of information. For example, literals may include dates, names, and/or numbers. In an example, the entity reference node “San Francisco” may be connected to a terminal node containing the literal “815,000” by an edge annotated with the property “Has Population.” In some implementations, terminal nodes may contain a reference or link to long text strings and other information stored in one or more documents external to the knowledge graph. In some implementations, literals are stored as nodes in the knowledge graph. In some implementations, literals are stored in the knowledge graph but are not assigned a unique identification reference as described below, and are not capable of being associated with multiple entity references. In some implementations, literal type nodes may define a type of literal, for example “Date/Time,” “Number,” or “GPS Coordinates.”

In some implementations, the grouping of an edge and two nodes is referred to as a triple. The triple represents the relationship between the nodes, or in some implementations, between the node and itself. In some implementations, higher order relationships are modeled, such as quaternary and n-ary relationships, where n is an integer greater than 2. In some implementations, information modeling the relationship is stored in a node, which may be referred to as a mediator node. In an example, the information “Person X Donates Artifact Y To Museum Z” is stored in a mediator node connected entity reference nodes to X, Y, and Z, where each edge identifies the role of each respective connected entity reference node.

In some implementations, the knowledge graph may include information for differentiation and disambiguation of terms and/or entities. As used herein, differentiation refers to the many-to-one situation where multiple names are associated with a single entity. As used herein, disambiguation refers to the one-to-many situation where the same name is associated with multiple entities. In some implementations, nodes may be assigned a unique identification reference. In some implementations, the unique identification reference may be an alphanumeric string, a name, a number, a binary code, any other suitable identifier, or any combination thereof. The unique identification reference may allow the search system to assign unique references to nodes with the same or similar textual identifiers. In some implementations, the unique identifiers and other techniques are used in differentiation, disambiguation, or both.

In some implementations of differentiation, a node may be associated with multiple terms or differentiation aliases in which the terms are associated with the same entity. For example, the terms “George Washington,” “Geo. Washington, “President Washington,” and “President George Washington” may all be associated with a single entity reference, e.g., a node, in the knowledge graph. This may provide differentiation and simplification in the knowledge graph.

In some implementations of disambiguation, multiple nodes with the same or similar names are defined by their unique identification references, by associated nodes in the knowledge graph, by any other suitable information, or any combination thereof. For example, there may be an entity reference node related to the city “Philadelphia,” an entity reference node related to the movie “Philadelphia,” and an entity reference node related to the cream cheese brand “Philadelphia.” Each of these nodes may have a unique identification reference, stored for example as a number, for disambiguation within the knowledge graph. In some implementations, disambiguation in the knowledge graph is provided by the connections and relationships between multiple nodes. For example, the city “New York” may be disambiguated from the state “New York” because the city is connected to an entity type “City” and the state is connected to an entity type “State.” It will be understood that more complex relationships may also define and disambiguate nodes. For example, a node may be defined by associated entity types, by other entity references connected to it by particular properties, by its name, by any other suitable information, or any combination thereof. These connections may be useful in disambiguating, for example, the node “Georgia” that is connected to the node “United States” may be understood represent the U.S. State, while the node “Georgia” connected to the nodes “Asia” and “Eastern Europe” may be understood to represent the country in eastern Europe.

In some implementations, a node may include or connect to data defining one or more attributes. The attributes may define a particular characteristic of the node. The particular attributes of a node may depend on what the node represents. In some implementations, an entity reference node may include or connect to: a unique identification reference, a list of entity types associated with the node, a list of differentiation aliases for the node, data associated with the entity reference, a textual description of the entity reference, links to a textual description of the entity reference, other suitable information, or any combination thereof. As described above, nodes may contain a reference or link to long text strings and other information stored in one or more documents external to the knowledge graph. In some implementations, the storage technique may depend on the particular information. For example, a unique identification reference may be stored within the node, a short information string may be stored in a terminal node as a literal, and a long description of an entity may be stored in an external document linked to by a reference in the knowledge graph.

An edge in a knowledge graph may represent a semantic connection defining a relationship between two nodes. The edge may represent a prepositional statement such as “Is A,” “Has A,” “Is Of A Type,” “Has Property,” “Has Value,” any other suitable statement, or any combination thereof. For example, the entity reference node of a particular person may be connected by a “Date Of Birth” edge to a terminal node containing a literal of his or her specific date of birth. In some implementations, the properties defined by edge connections of an entity reference may relate to nodes connected to the type of that entity reference. For example, the entity type node “Movie” may be connected to entity reference nodes “Actor” and “Director,” and a particular movie may be connected by an edge property “Has Actor” to an entity reference node representing a particular actor.

In some implementations, nodes and edges define the relationship between an entity type node and its properties, thus defining a schema. For example, an edge may connect an entity type node to a node associated with a property, which may be referred to as a property node. Entity references of the type may be connected to nodes defining particular values of those properties. For example, the entity type node “Person” may be connected to property node “Date of Birth” and a node “Height.” Further, the node “Date of Birth” may be connected to the literal type node “Date/Time,” indicating that literals associated with “Date of Birth” include date/time information. The entity reference node “George Washington,” which is connected to entity type node “Person” by an “Is A” edge, may also be connected to a literal “Feb. 22, 1732” by the edge “Has Date Of Birth.” In some implementations, the entity reference node “George Washington” is connected to a “Date Of Birth” property node. It will be understood that in some implementations, both schema and data are modeled and stored in a knowledge graph using the same technique. In this way, both schema and data can be accessed by the same search techniques. In some implementations, schemas are stored in a separate table, graph, list, other data structure, or any combination thereof. It will also be understood that properties may be modeled by nodes, edges, literals, any other suitable data, or any combination thereof.

For example, the entity reference node “George Washington” may be connected by an “Is A” edge to the entity type node representing “Person,” thus indicating an entity type of the entity reference, and may also be connected to a literal “Feb. 22, 1732” by the edge “Has Date Of Birth,” thus defining a property of the entity reference. In this way, the knowledge graph defines both entity types and properties associated with a particular entity reference by connecting to other nodes. In some implementations, “Feb. 22, 1732” may be a node, such that it is connected to other events occurring on that date. In some implementations, the date may be further connected to a year node, a month node, and a day of node. It will be understood that this information may be stored in any suitable combination of literals, nodes, terminal nodes, interconnected entity references, any other suitable arrangement, or any combination thereof.

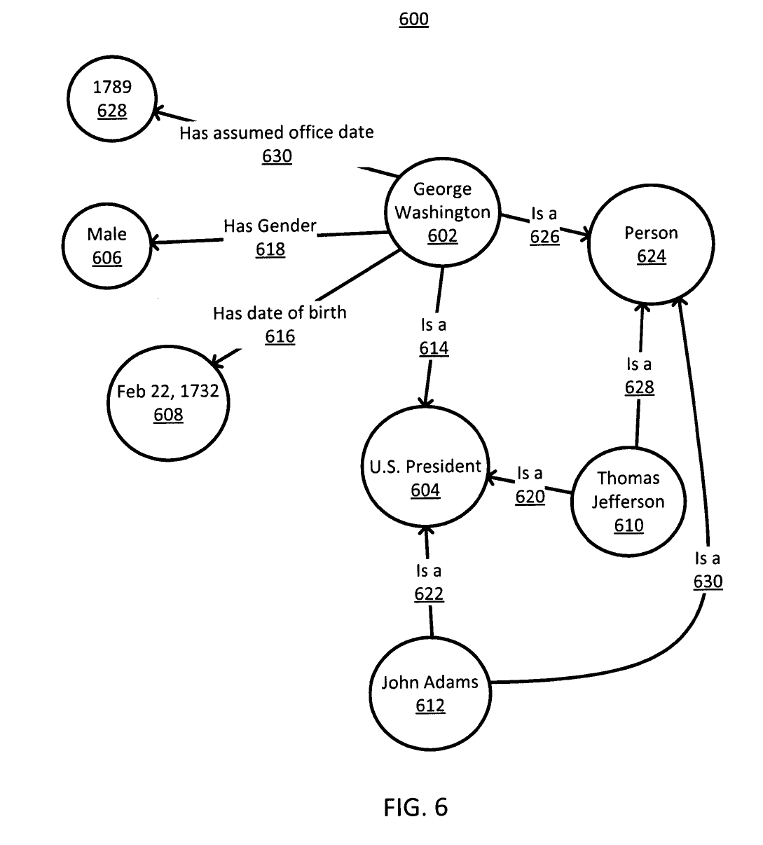

FIG. 6 shows illustrative knowledge graph portion 600. Knowledge graph portion 600 includes information related to the entity reference “George Washington,” represented by “George Washington” node 602. “George Washington” node 602 is connected to “U.S. President” entity type node 604 by “Is A” edge 614 with the semantic content “Is A,” such that the 3-tuple defined by nodes 602 and 604 and the edge 614 contains the information “George Washington is a U.S. President.” Similarly, the information “Thomas Jefferson Is A U.S. President” is represented by the tuple of “Thomas Jefferson” node 610, “Is A” edge 620, and “U.S. President” node 604. Knowledge graph portion 600 includes entity type nodes “Person” 624, and “U.S. President” node 604. The person type is defined in part by the connections from “Person” node 624. For example, the type “Person” is defined as having the property “Date Of Birth” by node 630 and edge 632, and is defined as having the property “Gender” by node 634 and edge 636. These relationships define in part a schema associated with the entity type “Person.”

“George Washington” node 602 is shown in knowledge graph portion 600 to be of the entity types “Person” and “U.S. President,” and thus is connected to nodes containing values associated with those types. For example, “George Washington” node 602 is connected by “Has Gender” edge 618 to “Male” node 606, thus indicating that “George Washington has gender “Male.” Further, “Male” node 606 may be connected to the “Gender” node 634 indicating that “Male Is A Type Of Gender.” Similarly, “George Washington” node 602 is be connected by “Has Date of Birth” edge 616 to “Feb. 22, 1732” node 608, thus indicating that “George Washington Has Date Of Birth Feb. 22, 1732.” “George Washington” node 602 may also be connected to “1789” node 628 by “Has Assumed Office Date” edge 630.

Knowledge graph portion 600 also includes “Thomas Jefferson” node 610, connected by “Is A” edge 620 to entity type “U.S. President” node 604 and by “Is A” edge 628 to “Person” entity type node 624. Thus, knowledge graph portion 600 indicates that “Thomas Jefferson” has the entity types “U.S. President” and “Person.” In some implementations, “Thomas Jefferson” node 610 is connected to nodes not shown in FIG. 6 referencing his date of birth, gender, and assumed office date.

It will be understood that knowledge graph portion 600 is merely an example and that it may include nodes and edges not shown. For example, “U.S. President” node 604 may be connected to all of the U.S. Presidents. “U.S. President” node 604 may also be connected to properties related to the entity type such as a duration of term, for example “4 Years,” a term limit, for example “2 Terms,” a location of office, for example “Washington D.C.,” any other suitable data, or any combination thereof. For example, “U.S. President” node 604 is connected to “Assumed Office Date” node 638 by “Has Property” edge 640, defining in part a schema for the type “U.S. President.” Similarly, “Thomas Jefferson” node 610 may be connected to any suitable number of nodes containing further information related to his illustrated entity type nodes “U.S. President,” and “Person,” and to other entity type nodes not shown such as “Inventor,” “Vice President,” and “Author.” In a further example, “Person” node 624 may be connected to all entity references in the knowledge graph with the type “Person.” In a further example, “1789” node 628 may be connected to all events in the knowledge graph with the property of year “1789.” “1789” node 628 is unique to the year 1789, and disambiguated from, for example, a book entitled “1789,” not shown in FIG. 6, by its unique identification reference. In some implementations, “1789” node 628 is connected to the entity type node “Year.”

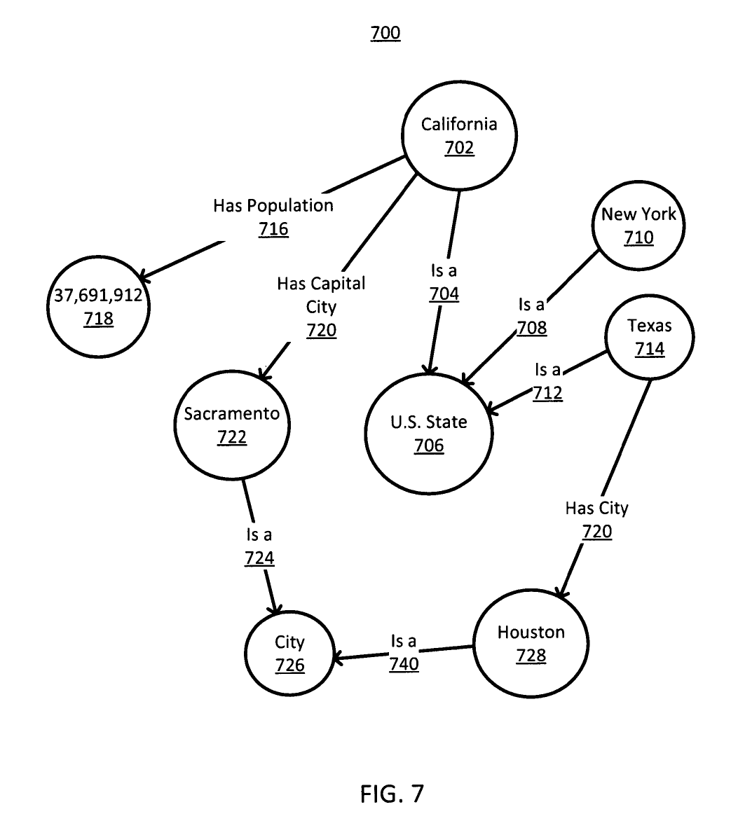

FIG. 7 shows illustrative knowledge graph portion 700. Knowledge graph portion 700 includes “California” node 702, which may also be associated with differentiation aliases such as, for example, “CA,” “Calif.,” “Golden State,” any other suitable differentiation aliases, or any combination thereof. In some implementations, these differentiations are stored in “California” node 702. California is connected by “Is A” edge 704 to the “U.S. State” entity type node 706. “New York” node 710 and “Texas” node 714 are also connected to “U.S. State” node 706 by “Is A” edges 708 and 712, respectively. “California” node 702 is connected by “Has Capital City” edge 720 to “Sacramento” node 722, indicating the information that “California Has Capital City Sacramento.” Sacramento node 722 is further connected by “Is A” edge 724 to the “City” entity type node 726. Similarly, “Texas” node 714 is connected by “Has City” edge 720 to “Houston” node 728, which is further connected to the “City” entity type node 726 by “Is A” edge 740. “California” node 702 is connected by “Has Population” edge 716 to node 718 containing the literal value “37,691,612.” In an example, the particular value “37,691,612” may be periodically automatically updated by the knowledge graph based on an external website or other source of data. Knowledge graph portion 700 may include other nodes not shown. For example, “U.S. State” entity type node 706 may be connected to nodes defining properties of that entity type such as “Population” and “Capital City.” These entity type—property relationships may be used to define other relationships in knowledge graph portion 700 such as “Has Population” edge 716 connecting entity reference node “California” 716 with terminal node 718 containing the literal defining the population of California.

It will be understood that while knowledge graph portion 600 of FIG. 6 and knowledge graph portion 700 of FIG. 7 below show portions of a knowledge graph, all pieces of information may be contained within a single graph and that these selections illustrated herein are merely an example. In some implementations, separate knowledge graphs are maintained for different respective domains, for different respective entity types, or according to any other suitable delimiting characteristic. In some implementations, separate knowledge graphs are maintained according to size constraints. In some implementations, a single knowledge graph is maintained for all entity references and entity types.

A knowledge graph may be implemented using any suitable software constructs. In an example, a knowledge graph is implemented using object oriented constructs in which each node is an object with associated functions and variables. Edges, in this context, may be objects having associated functions and variables. In some implementations, data contained in a knowledge graph, pointed to by nodes of a knowledge graph, or both, is stored in any suitable one or more data repositories across one or more servers located in one or more geographic locations coupled by any suitable network architecture.

FIG. 8 shows flow diagram 800 including illustrative steps for presenting search results in accordance with some implementations of the present disclosure.

In step 802, entity references are determined from a first search query. In some implementations, the entity references are entity references in a knowledge graph. For example, they may be represented as an entity reference node as described in FIG. 5. In some implementations, a first search query is received from a user using, for example, a keyboard or voice input. In some implementations, the search query is parsed to separate and identify elements of the query. In an example, a simple query such as “Dog” may not be partitioned, whereas a longer query such as “Skyscrapers In The United States” may be partitioned into “Skyscrapers” and “United States.”

In some implementations, queries may include user input of text, user input of images, data from another application such as a calendar or web browser, data generated based on an action such as opening an email or particular webpage, any other suitable data, or any combination thereof. In an example, the search system may receive data related to an event in a calendar program, and may identify an entity based on that data. In some implementations, the providing the query is automatic, in response to user input, in response to user preferences, based on any other suitable parameters, or any combination thereof.

In some implementations, entity references are identified in the search query based on entity references and entity types in the knowledge graph. In an example, the search system may identify a “Skyscraper” entity reference in the knowledge graph in relation to a partitioned query element “Skyscrapers.” As described above, this entity reference may be associated with other aliases of skyscrapers such as “tall building” and “Highrise,” such that the same entity reference in the knowledge graph is identified for several first search queries. In some implementations, an entity type associated with the entity reference identified in the search query may be used to determine an organizing property as described below in step 804.

In some implementations, the search system may identify more than one entity reference in a knowledge graph related to the search query. The search system may select one of the identified entity references based on relevance and/or popularity data, by any other suitable technique, or any combination thereof. For example, the search term “New York” may be associated with entity references in the knowledge graph for the city of New York, N.Y., the state of New York, N.Y. University, or York, England. The system may determine that the city of New York, N.Y. is the most popular and thus the desired entity references. In some implementations, the selection may be based in part on other elements of the search query, a user's search history, a user's preferences, a user's geographic location, other contextual data, any other suitable information, or any combination thereof. For example, the system may associate the search query term “Portland” with a knowledge graph entity reference relating to the city Portland, Me. rather than Portland, Oreg. based on the geographic location of the user. In some implementations, the system may provide one or more entity references to the user for selection or refinement. For example, the search system may provide the question to the user “Did you mean Portland, Mass. or Portland, Oreg.?” and based further processing on a received response.

In some implementations, the search system may use search query terms in part to identify an entity reference in a knowledge graph. For example, words, contextual information, metadata, any other suitable content, or any combination thereof, may be used. For example, the search system may receive the query “Philadelphia Movie” and identify the entity reference associated with the movie “Philadelphia,” rather than the city Philadelphia, Pa. In some implementations, for example where the search query is provided by an application, metadata includes information corresponding to a query such as the name of the application from which the query was provided.

In step 804, data associated with the entity reference is identified, the data comprising an organizing property. In some implementations, the search system identifies an organizing property corresponding to the entity reference identified in step 802.

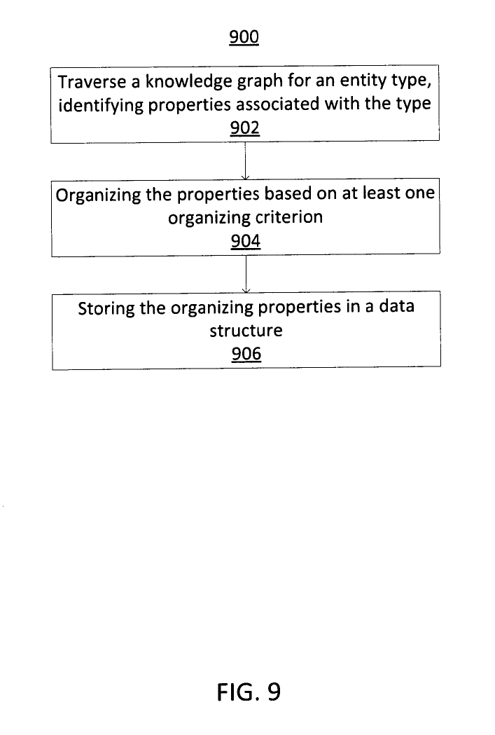

In some implementations, the system identifies a schema table associated with the entity type identified in step 802. In some implementations, the organizing property is determined based on the schema table. In some implementations, the schema table is predetermined, as described below in flow diagram 900 of FIG. 9. In some implementations, the schema table is ranked based on relevance data, popularity data, manually ordered, automatically ordered, arranged by any other suitable technique, or any combination thereof. In some implementations, the organizing property may be the highest ranked property of the schema table. In some implementations, a schema table may have multiple rankings, and the search system may select a ranking from the multiple rankings for use in determining an organizing property. In some implementations, the selection is based on relevance data, system settings, user preferences, the search query, any other suitable data, or any combination thereof. In some implementations, the schema table is stored in the knowledge graph, in a data base, in any other suitable location, or any combination thereof. In some implementations where the schema table is stored external to the knowledge graph, a reference, e.g., an identifier, is stored in the knowledge graph and points to the location schema table.

In an example, the schema table corresponding to the the entity reference “Dog” includes properties such as “Breed,” “Color,” “Size,” other suitable properties, or any combination thereof. In some implementations, the organizing property is selected from the schema table based on relevance and/or popularity data. For example, “Breed” may be the most popular property associated with the entity reference “Dog.” In some implementations, the ranking of properties within the schema table may be preprocessed, such that an organizing property is identified before receiving the search query. In some implementations, an organizing property may be selected based on the received search query. For example, if the received search query is “Dog Color,” the search system may use “Color” as the organizing property. In some implementations, the system may provide one or more organizing properties to the user for selection and/or refinement.

In some implementations, the organizing property may be selected by the user initially before search results are presented, or after initial search results are presented to refine or alter the presented content. In an example, the search system may present the user with organizing properties “Breed,” “Color,” “Size,” and “Coat Length” in response to the search query “Dog,” and determine the organizing property based on a selection. In another example, alternative organizing properties may be presented along with search results based the automatically selected property “Breed,” allowing the user to pivot between collections of results using different organizing properties.

In step 806, a second search query is generated based on the organizing property. In some implementations, more than one second search query is generated. The search system may retrieve, generate, or otherwise acquire a list of query terms associated with the organizing property. In some implementations, the schema table includes a list of, or reference to, entity references associated with the organizing property. In some implementations, those associated entity references are used to generate second search queries. In some implementations, query terms are identified as entity references linked to the organizing property in a knowledge graph. For example, where the organizing property is “Breed” associated with the entity reference “Dog,” the system may retrieve associated entity references “Afghan Hound,” “Border Collie,” and “Doberman,” and “German Shepherd.”

In some implementations, second search queries are determined based in part on the knowledge graph. For example, the associated entity references may be entities references in a knowledge graph. In some implementations, the schema table is built based on data in the knowledge graph, and thus when it is used to determine an organzing property and to identify associated entity references, the identification is based in part on data from the knowledge graph.

In some implementations, for example where there are a small number of query terms, all of the query terms are used to generate second search queries. In some implementations, for example where there are a large number of query terms, the search system may use a selection of the terms to generate a second search queries. In some implementations, the selection is based on, for example, relevance and/or popularity data.

In some implementations, the second search queries are generated by concatenating the first search query with each of the second search query terms. For example, where the first search query is “Dog” and the organizing property is “Breed,” the system may generate second search queries by concatenating “Dog” with particular instances of breed identified in the knowledge graph. In an example, the search system generates the second search queries: “Dog Afghan Hound,” “Dog Border Collie,” “Dog Doberman,” and “Dog German Shepherd.” In some implementations, the first search query is replaced with a search term associated with the identified entity reference in the knowledge graph. For example, where the first search term was “NYC,” which the search system associated with the entity reference “New York City,” the second search term may include the term “New York City,” rather than “NYC,” in combination with the terms associated with the organizing property.

In some implementations, where two organizing properties are identified, second search queries may be based on a first organizing property, a second organizing property, or a combination of both. It will be understood that where more than two properties are identified, suitable selections and combinations are used. For example, if the organizing properties selected in response to the search query “Dog” are both “Breed” and “Color,” second search queries may include “Dog Chocolate Labrador,” “Dog Yellow Lab,” “Dog German Shepherd” and “Dog White.”

In step 808, search results are generated based on the one or more second search queries generated in step 808. In some implementations, search results include one or more entity references from the knowledge graph. In the above example, where one of the second search queries was “Dog Border Collie,” search results may include information related to Border Collies as identified using the knowledge graph such as properties associated with the Border Collie entity reference in the knowledge graph. In another example, search results may include images, video, webpages, audio, or other suitable content associated with the Border Collie entity reference in the knowledge graph. In another example, search results may include other entity references in the knowledge graph associated with, similar to, or related to the entity reference “Border Collie.”

In some implementations, search results may include image search results, video search results, textual search results, map search results, any other suitable results, or any combination thereof. Search results may relate to the Internet, information stored in a knowledge graph, a public or private database, any other suitable searchable collection of data, any index of any suitable collection of data, or any combination thereof. Specific databases may include, for example, a collection of restaurant reviews stored by a website, social media profile pages, the inventory files of a company, any other suitable database, or any combination thereof.

In some implementations, the system may determine a particular type of search, for example, a video search or an image search, based on the search query. For example, one or more second search queries related to dog breeds may return image search results. In another example, one or more second search queries related to movie titles may return video results. In another example, where the search query was received from a calendar application, search may include a timeline search. In some implementations, the identification of the type of search may be based on relevance and/or popularity data, e.g., based on prior selections of users searching for the same or similar content, based on an element of the received search query, based on predefined content in the search system, based on any other suitable parameter, or any combination thereof. An element of the received search query may include an explicit identification such as “Images Of Dogs” or “Audio By Bach.” The search system may also identify implicit indications of a search type within the received search query. Predefined parameters in the search system may include automatically or manually generated associations with particular knowledge graph schema tables or entity references with a particular search type.

In step 810, the search results are presented. The search results include results generated based on the second search query in step 808. In some implementations, presentation of search results is based in part on data from the knowledge graph. In some implementations, search results are presented as illustrated in user interface 200 of FIG. 2, user interface 300 of FIG. 3, user interface 400 of FIG. 4, any other suitable presentation technique, or any combination thereof.

In some implementations, the search results are arranged in a particular order. For example, each of the one or more sets of results associated with the one or more second search queries may occupy a portion of the page such as a row or column. The rows may be ordered alphabetically, numerically, or based on some other metric. Metrics may include relevance data, popularity data, any other suitable metric, an index based on content such as webpages, or any combination thereof. The ranking technique may be based in part on the relevance of the search results, user preferences, predetermined general settings of the search system, predetermined settings of the search system associated with a particular entity reference, type, or value in the knowledge graph, based on the number of second search queries generated, based on search history, based on any other suitable parameters, or any combination thereof.

For example, where the second search queries are related to dog breeds such as “Dog Afghan Hound,” “Dog Border Collie,” “Dog Golden Retriever,” and “Dog Greater Swiss Mountain Dog” “Dog Yorkshire Terrier,” among others, the search system may order the sets of search results alphabetically based on the letters of the first word of the second search query term. In this example, the first set of search results may relate to “Dog Afghan Hound” and end with “Dog Yorkshire Terrier.” In another example, the results may be ordered based on search popularity, where the popular breed “Dog Golden Retriever” may be ordered first and a less popular breed such as “Dog Greater Swiss Mountain Dog” may be further down the page.

In another example, where the first search query is for “U.S. Presidents” the organizing property may be “Names,” and thus the second search queries will be generated using a list of the names of the Presidents, for example, “U.S. President George Washington,” “U.S. President John Adams,” “U.S. President Thomas Jefferson,” up to the current president. In some implementations, because this is a relatively short and finite list, all of the presidents may be included. The second search results may be ordered based on the decade or year of their Presidency. The order of this numerical ranking, e.g., most recent first or oldest first, may be based on relevance and/or popularity data, based on information stored in the knowledge graph, based on an implicit or explicit indication in the received search query, based on any other suitable information, or any combination thereof.

In some implementations, the search system may provide different levels of granularity in subdividing a set. For example, where the first search query is “U.S. Presidents” and the organizing property is “years in office,” second search queries may include groupings in 1, 5, 10, 20, or 50 year increments. In some implementations, the granularity may be based on user input, the first search query, user preferences, the search results, any other suitable data, or any combination thereof. For example, second search queries may be generated such that search results are divided into 10 evenly spaced subunits. In another example, second search queries may be generated such that search results are divided evenly into 10 subunits, e.g., with a constant histogram. In some implementations, an uneven mixture may be used such that desired content is emphasized, or for other suitable reasons. In some implementations, subdivisions and/or granularity information may be predetermined and stored in a data structure. It will be understood that the aforementioned is merely an example and that second search queries may subdivide collections of search results based by any suitable technique.

In some implementations, the search system orders the search results within each set related to a particular second search query. For example, the search results related to the second search query “Dog Afghan Hound” may be ordered based on any of the methods described above, such popularity data, relevance data, and/or information stored in a knowledge graph.

FIG. 9 shows flow diagram 900 including illustrative steps for determining organizing properties in accordance with some implementations of the present disclosure. In some implementations, flow diagram 900 describes building and storing schema tables based on data in the knowledge graph. In some implementations, the schema tables of flow diagram 900 are used in step 804 of FIG. 8. In some implementations, flow diagram 900 describes steps used to identify organizing properties associated with entity references stored in a knowledge graph. In some implementations, the steps of flow diagram 900 are preprocessed, e.g., carried out offline, such that the organizing properties are predetermined at the time of receiving a search query.

In step 902, the search system traverses a knowledge graph for an entity type, identifying properties associated with the type. In some implementations, the knowledge graph contains entity types, as described above. In some implementations, the search system maps all of the properties associated with that entity type, and stores the identified properties as a schema table, list, table, in any other suitable format, or any combination thereof. In an example, the search system traverses the graph to find properties associated with entity type “Person” such as “Name,” “Age,” “Place of Birth,” and so on. In the example, the search system compiles these associated properties to generate a list such as a schema table. In some implementations, the schema table is stored in the knowledge graph, in a database, in any other suitable location, or any combination thereof. In some implementations, the knowledge graph contains a reference to the schema table when it is not stored in the knowledge graph.

In step 904, the search system organizes the properties based on at least one organizing criterion. In some implementations, the search system ranks or otherwise orders, the properties of the schema table. In some implementations, the organizing criterion includes relevance and/or popularity data, co-occurrence, user search history, user preferences, global search history, system settings, system developer input, any other suitable data, or any combination thereof. In some implementations, the organizing criterion includes manual ordering of a list by a system developer. In some implementations, more than one criterion is used. In some implementations, multiple criteria are combined by a weighted technique. In some implementations, the organized properties may include an organizing property as used in step 804 of FIG. 8.

In step 906, the search system stores the organizing properties in a data structure. In some implementations, the organized properties are stored as a schema table. In some implementations, the search system stores the properties organized in step 904 in the knowledge graph, in a database, in any other suitable data structure, or any combination thereof. In some implementations, where the organized properties are not stored in the knowledge graph, a reference to the data containing the organized properties is stored in the knowledge graph.

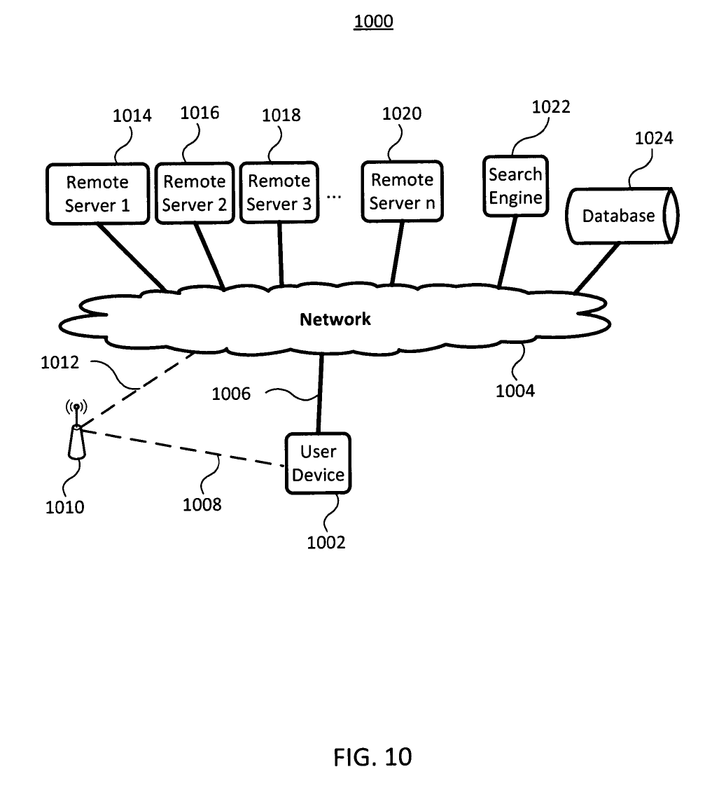

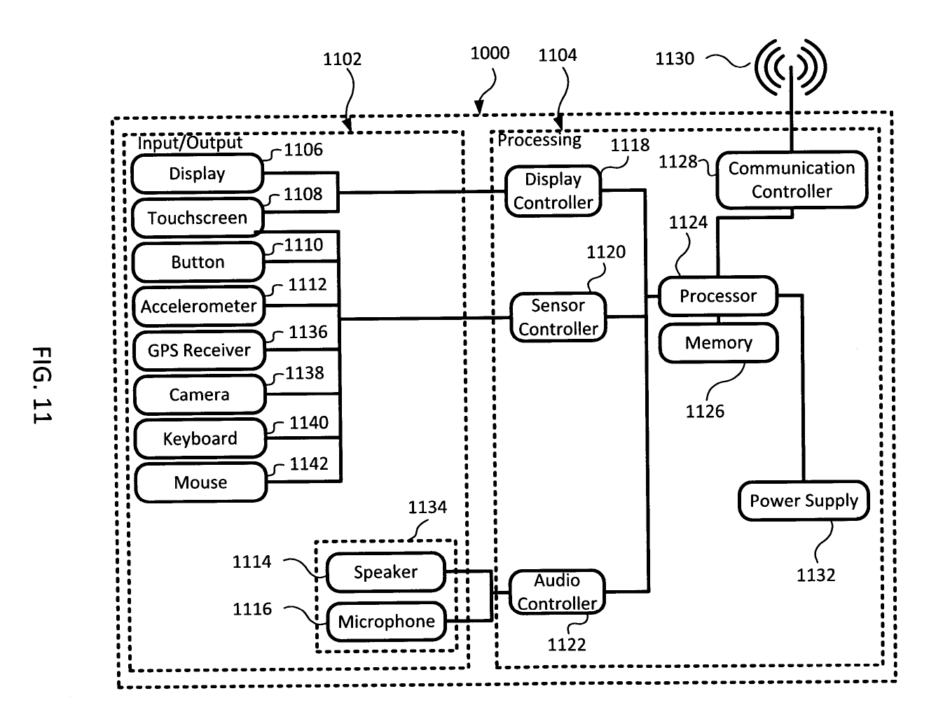

The following description and accompanying FIGS. 10-11 describe illustrative computer systems that may be used in some implementations of the present disclosure. It will be understood that the knowledge graph and associated techniques may be implemented on any suitable computer or combination of computers.

FIG. 10 shows illustrative search system 1000 in accordance with some implementations of the present disclosure. System 1000 may include one or more user device 1002. In some implementations, user device 1002 may include a smartphone, tablet computer, desktop computer, laptop computer, personal digital assistant, portable audio player, portable video player, mobile gaming device, other suitable user device capable of providing content, or any combination thereof.

User device 1002 may be coupled to network 1004 directly through connection 1006, through wireless repeater 1010, by any other suitable way of coupling to network 1004, or by any combination thereof. Network 1004 may include the Internet, a dispersed network of computers and servers, a local network, a public intranet, a private intranet, other coupled computing systems, or any combination thereof.

User device 1002 may be coupled to network 1004 by wired connection 1006. Connection 1006 may include Ethernet hardware, coaxial cable hardware, DSL hardware, T-1 hardware, fiber optic hardware, analog phone line hardware, any other suitable wired hardware capable of communicating, or any combination thereof. Connection 1006 may include transmission techniques including TCP/IP transmission techniques, IEEE 1102 transmission techniques, Ethernet transmission techniques, DSL transmission techniques, fiber optic transmission techniques, ITU-T transmission techniques, any other suitable transmission techniques, or any combination thereof.

User device 1002 may be wirelessly coupled to network 1004 by wireless connection 1008. In some implementations, wireless repeater 1010 receives transmitted information from user device 1002 by wireless connection 1008 and communicates it with network 1004 by connection 1012. Wireless repeater 1010 receives information from network 1004 by connection 1012 and communicates it with user device 1002 by wireless connection 1008. In some implementations, wireless connection 1008 may include cellular phone transmission techniques, code division multiple access or CDMA transmission techniques, global system for mobile communications or GSM transmission techniques, general packet radio service or GPRS transmission techniques, satellite transmission techniques, infrared transmission techniques, Bluetooth transmission techniques, Wi-Fi transmission techniques, WiMax transmission techniques, any other suitable transmission techniques, or any combination thereof.

Connection 1012 may include Ethernet hardware, coaxial cable hardware, DSL hardware, T-1 hardware, fiber optic hardware, analog phone line hardware, wireless hardware, any other suitable hardware capable of communicating, or any combination thereof. Connection 1012 may include wired transmission techniques including TCP/IP transmission techniques, IEEE 1102 transmission techniques, Ethernet transmission techniques, DSL transmission techniques, fiber optic transmission techniques, ITU-T transmission techniques, any other suitable transmission techniques, or any combination thereof. Connection 1012 may include may include wireless transmission techniques including cellular phone transmission techniques, code division multiple access or CDMA transmission techniques, global system for mobile communications or GSM transmission techniques, general packet radio service or GPRS transmission techniques, satellite transmission techniques, infrared transmission techniques, Bluetooth transmission techniques, Wi-Fi transmission techniques, WiMax transmission techniques, any other suitable transmission techniques, or any combination thereof.

Wireless repeater 1010 may include any number of cellular phone transceivers, network routers, network switches, communication satellites, other devices for communicating information from user device 1002 to network 1004, or any combination thereof. It will be understood that the arrangement of connection 1006, wireless connection 1008 and connection 1012 is merely illustrative and that system 1000 may include any suitable number of any suitable devices coupling user device 1002 to network 1004. It will also be understood that any user device 1002, may be communicatively coupled with any user device, remote server, local server, any other suitable processing equipment, or any combination thereof, and may be coupled using any suitable technique as described above.

In some implementations, any suitable number of remote servers 1014, 1016, 1018, 1020, may be coupled to network 1004. Remote servers may be general purpose, specific, or any combination thereof. One or more search engine servers 1022 may be coupled to the network 1004. In some implementations, search engine server 1022 may include the knowledge graph, may include processing equipment configured to access the knowledge graph, may include processing equipment configured to receive search queries related to the knowledge graph, may include any other suitable information or equipment, or any combination thereof. One or more database servers 1024 may be coupled to network 1004. In some implementations, database server 1024 may store the knowledge graph. In some implementations, where there is more than one knowledge graph, the more than one may be included in database server 1024, may be distributed across any suitable number of database servers and general purpose servers by any suitable technique, or any combination thereof. It will also be understood that the search system may use any suitable number of general purpose, specific purpose, storage, processing, search, any other suitable server, or any combination.

FIG. 11 is a block diagram of a user device of the illustrative computer system of FIG. 10 in accordance with some implementations of the present disclosure. User device 1002 may include input/output equipment 1102 and processing equipment 1104. Input/output equipment 1102 may include display 1106, touchscreen 1108, button 1110, accelerometer 1112, global positions system or GPS receiver 1136, camera 1138, keyboard 1140, mouse 1142, and audio equipment 1134 including speaker 1114 and microphone 1116. In some implementations, the equipment illustrated in FIG. 11 may be representative of equipment included in a smartphone user device. It will be understood that the specific equipment included in the illustrative computer system may depend on the style of user device. For example, the Input/output equipment 1102 of a desktop computer may include a keyboard 1140 and mouse 1142 and may omit accelerometer 1112 and GPS receiver 1136. It will be understood that user device 1002 may omit any suitable illustrated elements, and may include equipment not shown such as media drives, data storage, communication devices, display devices, processing equipment, any other suitable equipment, or any combination thereof.

In some implementations, display 1106 may include a liquid crystal display, light emitting diode display, organic light emitting diode display, amorphous organic light emitting diode display, plasma display, cathode ray tube display, projector display, any other suitable display capable of displaying content, or any combination thereof. Display 1106 may be controlled by display controller 1118 or by processor 1124 in processing equipment 1104, by processing equipment internal to display 1106, by other controlling equipment, or by any combination thereof. In some implementations, display 1106 may display data from a knowledge graph.

Touchscreen 1108 may include a sensor capable of sensing pressure input, capacitance input, resistance input, piezoelectric input, optical input, acoustic input, any other suitable input, or any combination thereof. Touchscreen 1108 may be capable of receiving touch-based gestures. Received gestures may include information relating to one or more locations on the surface of touchscreen 1108, pressure of the gesture, speed of the gesture, duration of the gesture, direction of paths traced on its surface by the gesture, motion of the device in relation to the gesture, other suitable information regarding a gesture, or any combination thereof. In some implementations, touchscreen 1108 may be optically transparent and located above or below display 1106. Touchscreen 1108 may be coupled to and controlled by display controller 1118, sensor controller 1120, processor 1124, any other suitable controller, or any combination thereof. In some implementations, touchscreen 1108 may include a virtual keyboard capable of receiving, for example, a search query used to identify data in a knowledge graph.

In some embodiments, a gesture received by touchscreen 1108 may cause a corresponding display element to be displayed substantially concurrently, e.g., immediately following or with a short delay, by display 1106. For example, when the gesture is a movement of a finger or stylus along the surface of touchscreen 1108, the search system may cause a visible line of any suitable thickness, color, or pattern indicating the path of the gesture to be displayed on display 1106. In some implementations, for example, a desktop computer using a mouse, the functions of the touchscreen may be fully or partially replaced using a mouse pointer displayed on the display screen.

Button 1110 may be one or more electromechanical push-button mechanism, slide mechanism, switch mechanism, rocker mechanism, toggle mechanism, other suitable mechanism, or any combination thereof. Button 1110 may be included in touchscreen 1108 as a predefined region of the touchscreen, e.g., soft keys. Button 1110 may be included in touchscreen 1108 as a region of the touchscreen defined by the search system and indicated by display 1106. Activation of button 1110 may send a signal to sensor controller 1120, processor 1124, display controller 1120, any other suitable processing equipment, or any combination thereof. Activation of button 1110 may include receiving from the user a pushing gesture, sliding gesture, touching gesture, pressing gesture, time-based gesture, e.g., based on the duration of a push, any other suitable gesture, or any combination thereof.

Accelerometer 1112 may be capable of receiving information about the motion characteristics, acceleration characteristics, orientation characteristics, inclination characteristics and other suitable characteristics, or any combination thereof, of user device 1002. Accelerometer 1112 may be a mechanical device, microelectromechanical or MEMS device, nanoelectromechanical or NEMS device, solid state device, any other suitable sensing device, or any combination thereof. In some implementations, accelerometer 1112 may be a 3-axis piezoelectric microelectromechanical integrated circuit which is configured to sense acceleration, orientation, or other suitable characteristics by sensing a change in the capacitance of an internal structure. Accelerometer 1112 may be coupled to touchscreen 1108 such that information received by accelerometer 1112 with respect to a gesture is used at least in part by processing equipment 1104 to interpret the gesture.

Global positioning system or GPS receiver 1136 may be capable of receiving signals from global positioning satellites. In some implementations, GPS receiver 1136 may receive information from one or more satellites orbiting the earth, the information including time, orbit, and other information related to the satellite. This information may be used to calculate the location of user device 1002 on the surface of the earth. GPS receiver 1136 may include a barometer, not shown, to improve the accuracy of the location. GPS receiver 1136 may receive information from other wired and wireless communication sources regarding the location of user device 1002. For example, the identity and location of nearby cellular phone towers may be used in place of, or in addition to, GPS data to determine the location of user device 1002.

Camera 1138 may include one or more sensors to detect light. In some implementations, camera 1138 may receive video images, still images, or both. Camera 1138 may include a charged coupled device or CCD sensor, a complementary metal oxide semiconductor or CMOS sensor, a photocell sensor, an IR sensor, any other suitable sensor, or any combination thereof. In some implementations, camera 1138 may include a device capable of generating light to illuminate a subject, for example, an LED light. Camera 1138 may communicate information captured by the one or more sensor to sensor controller 1120, to processor 1124, to any other suitable equipment, or any combination thereof. Camera 1138 may include lenses, filters, and other suitable optical equipment. It will be understood that user device 1002 may include any suitable number of camera 1138.

Audio equipment 1134 may include sensors and processing equipment for receiving and transmitting information using acoustic or pressure waves. Speaker 1114 may include equipment to produce acoustic waves in response to a signal. In some implementations, speaker 1114 may include an electroacoustic transducer wherein an electromagnet is coupled to a diaphragm to produce acoustic waves in response to an electrical signal. Microphone 1116 may include electroacoustic equipment to convert acoustic signals into electrical signals. In some implementations, a condenser-style microphone may use a diaphragm as a portion of a capacitor such that acoustic waves induce a capacitance change in the device, which may be used as an input signal by user device 1002.

Speaker 1114 and microphone 1116 may be contained within user device 1002, may be remote devices coupled to user device 1002 by any suitable wired or wireless connection, or any combination thereof.

Speaker 1114 and microphone 1116 of audio equipment 1134 may be coupled to audio controller 1122 in processing equipment 1104. This controller may send and receive signals from audio equipment 1134 and perform pre-processing and filtering steps before transmitting signals related to the input signals to processor 1124. Speaker 1114 and microphone 1116 may be coupled directly to processor 1124. Connections from audio equipment 1134 to processing equipment 1104 may be wired, wireless, other suitable arrangements for communicating information, or any combination thereof.

Processing equipment 1104 of user device 1002 may include display controller 1118, sensor controller 1120, audio controller 1122, processor 1124, memory 1126, communication controller 1128, and power supply 1132.

Processor 1124 may include circuitry to interpret signals input to user device 1002 from, for example, touchscreen 1108 and microphone 1116. Processor 1124 may include circuitry to control the output to display 1106 and speaker 1114.

Processor 1124 may include circuitry to carry out instructions of a computer program. In some implementations, processor 1124 may be an integrated electronic circuit based, capable of carrying out the instructions of a computer program and include a plurality of inputs and outputs.

Processor 1124 may be coupled to memory 1126. Memory 1126 may include random access memory or RAM, flash memory, programmable read only memory or PROM, erasable programmable read only memory or EPROM, magnetic hard disk drives, magnetic tape cassettes, magnetic floppy disks optical CD-ROM discs, CD-R discs, CD-RW discs, DVD discs, DVD+R discs, DVD-R discs, any other suitable storage medium, or any combination thereof.

The functions of display controller 1118, sensor controller 1120, and audio controller 1122, as have been described above, may be fully or partially implemented as discrete components in user device 1002, fully or partially integrated into processor 1124, combined in part or in full into combined control units, or any combination thereof.

Communication controller 1128 may be coupled to processor 1124 of user device 1002. In some implementations, communication controller 1128 may communicate radio frequency signals using antenna 1130. In some implementations, communication controller 1128 may communicate signals using a wired connection, not shown. Wired and wireless communications communicated by communication controller 1128 may use Ethernet, amplitude modulation, frequency modulation, bitstream, code division multiple access or CDMA, global system for mobile communications or GSM, general packet radio service or GPRS, satellite, infrared, Bluetooth, Wi-Fi, WiMax, any other suitable communication configuration, or any combination thereof. The functions of communication controller 1128 may be fully or partially implemented as a discrete component in user device 1002, may be fully or partially included in processor 1124, or any combination thereof. In some implementations, communication controller 1128 may communicate with a network such as network 1004 of FIG. 10 and may receive information from a knowledge graph stored, for example, in database 1024 of FIG. 10.

Power supply 1132 may be coupled to processor 1124 and to other components of user device 1002. Power supply 1132 may include a lithium-polymer battery, lithium-ion battery, NiMH battery, alkaline battery, lead-acid battery, fuel cell, solar panel, thermoelectric generator, any other suitable power source, or any combination thereof. Power supply 1132 may include a hard wired connection to an electrical power source, and may include electrical equipment to convert the voltage, frequency, and phase of the electrical power source input to suitable power for user device 1002. In some implementations of power supply 1132, a wall outlet may provide 120V, 60 Hz alternating current or AC. A circuit of transformers, resistors, inductors, capacitors, transistors, and other suitable electronic components included in power supply 1132 may convert the 120V AC from a wall outlet power to 5 volts at 0 Hz, e.g., 5V DC. In some implementations of power supply 1132, a lithium-ion battery including a lithium metal oxide-based cathode and graphite-based anode may supply 3.7V to the components of user device 1002. Power supply 1132 may be fully or partially integrated into user device 1002, or may function as a stand-alone device. Power supply 1132 may power user device 1002 directly, may power user device 1002 by charging a battery, may provide power by any other suitable way, or any combination thereof.

The foregoing is merely illustrative of the principles of this disclosure and various modifications may be made by those skilled in the art without departing from the scope of this disclosure. The above described implementations are presented for purposes of illustration and not of limitation. The present disclosure also may take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed:

1. A computer implemented method for displaying search results, the method comprising:
determining, using one or more computers, an entity reference from a first search query;
identifying, using one or more computers, data associated with the entity reference, the data comprising an organizing property, wherein the data is derived from a knowledge graph, and wherein the data is associated with one or more types in the knowledge graph;
generating, using one or more computers, a second search query based on the organizing property;
causing, using one or more computers, search results to be generated based on the second search query; and
causing to be presented, using one or more computers, the search results in an arrangement according to the organizing property.

2. The method of claim 1, wherein the organizing property comprises a schema table.

3. The method of claim 1, wherein generating the second search query comprises:
identifying an associated entity reference, wherein the associated entity reference is identified based on connections to the organizing property and the entity reference in the knowledge graph; and
generating the second search query based on the entity reference and the associated entity reference.

4. The method of claim 1, wherein causing search results to be generated comprises retrieving search results from the knowledge graph.

5. The method of claim 1, wherein causing to be presented the search results comprises arranging the search results based on a metric.

6. The method of claim 1, wherein causing the search results to be generated based on the second search query comprises causing image search results to be generated.

7. The method of claim 1, wherein causing the search results to be generated based on the second search query comprise video search results.

8. The method of claim 1, wherein causing the search results to be generated based on the second search query comprises causing textual search results to be generated.

9. The method of claim 1, wherein causing to be presented the search results comprises displaying search results in a portion of the display screen.

10. A system for presenting search results, the system comprising:
a database comprising a knowledge graph; and
one or more computers configured to perform operations comprising:
determining an entity reference from a first search query,
identifying data associated with the entity reference, the data comprising an organizing property, wherein the data is derived from a knowledge graph, and wherein the data is associated with one or more types in the knowledge graph,
generating a second search query based on the organizing property,
causing search results to be generated based on the second search query, and
causing to be presented the search results in an arrangement according to the organizing property.

11. The system of claim 10, wherein the organizing property comprises a schema table.

12. The system of claim 10, wherein the one or more computers are further configured to perform operations comprising:
identifying an associated entity reference, wherein the associated entity reference is identified based on connections to the organizing property and the entity reference in the knowledge graph; and
generating the second search query based on the entity reference and the associated entity reference.

13. The system of claim 10, wherein the one or more computers are further configured to retrieve search results from the knowledge graph.

14. The system of claim 10, wherein the one or more computers are further configured to arrange search results based on a metric.

15. The system of claim 10, the search results comprise image search results.

16. The system of claim 10, wherein the search results comprise video search results.

17. The system of claim 10, wherein the search results comprise textual search results.

18. The system of claim 10, wherein causing to be presented the search results comprises displaying search results in a portion of the display screen.

19. A non-transitory computer-readable medium for use in presenting search results, the computer-readable medium having computer program instructions recorded thereon for:
determining, using one or more computers, an entity reference from a first search query;
identifying, using one or more computers, data associated with the entity reference, the data comprising an organizing property, wherein the data is derived from a knowledge graph, and wherein the data is associated with one or more types in the knowledge graph;
generating, using one or more computers, a second search query based on the organizing property;
causing, using one or more computers, search results to be generated based on the second search query; and
causing to be presented, using one or more computers, the search results in an arrangement according to the organizing property.

20. The non-transitory computer readable medium of claim 19, wherein the organizing property comprises a schema table.

21. The non-transitory computer readable medium of claim 19, wherein generating the second search query comprises:
identifying an associated entity reference, wherein the associated entity reference is identified based on connections to the organizing property and the entity reference in the knowledge graph; and
generating the second search query based on the entity reference and the associated entity reference.

22. The non-transitory computer readable medium of claim 19, wherein causing search results to be generated comprises retrieving search results from the knowledge graph.

23. The non-transitory computer readable medium of claim 19, wherein causing to be presented the search results comprises arranging the search results based on a metric.

24. The non-transitory computer readable medium of claim 19, wherein causing the search results to be generated based on the second search query comprises causing image search results to be generated.

25. The non-transitory computer readable medium of claim 19, wherein causing the search results to be generated based on the second search query comprise video search results.

26. The non-transitory computer readable medium of claim 19, wherein causing the search results to be generated based on the second search query comprises causing textual search results to be generated.

27. The non-transitory computer readable medium of claim 19, wherein causing to be presented the search results comprises displaying search results in a portion of the display screen.

28. A computer implemented method for organizing search results, the method comprising:
traversing, using one or more computers, a knowledge graph to identify entity types, and to identify properties associated with each identified entity type;
for each identified entity type, organizing, using one or more computers, the properties associated with the respective entity type based on at least one organizing criterion into organized properties; and
storing, using one or more computers, the organized properties in a data structure that is usable to arrange search results based on the organized properties.

29. The method of claim 28, wherein traversing the knowledge graph comprises following linked nodes in the knowledge graph.

30. The method of claim 28, wherein organizing the properties comprises receiving user input.

31. The method of claim 28, wherein the at least one organizing criterion comprises relevance data.

32. The method of claim 28, wherein the at least one organizing criterion comprises co-occurrence.

33. The method of claim 28, wherein storing the organized properties in a data structure comprises storing the organized properties in the knowledge graph.

34. The method of claim 28, wherein organizing the properties comprises ordering the properties based on relevance data.

35. The method of claim 28, wherein organizing the properties comprises ordering the properties based on a co-occurrence index.

36. The method of claim 28, wherein storing the organized properties in a data structure comprises storing organized properties and the associated type.

37. The method of claim 28, wherein storing the organized properties comprises storing a schema table.

38. A system for presenting search results, the system comprising:
a database comprising a knowledge graph; and
one or more computers configured to perform operations comprising:
traversing the knowledge graph to identify entity types, and to identify properties associated with each identified entity type,
for each identified entity type, organizing the properties associated with the respective entity type based on at least one organizing criterion into organized properties, and
storing the organized properties in a data structure that is usable to arrange search results based on the organized properties.

39. The system of claim 38, wherein traversing the knowledge graph comprises following linked nodes in the knowledge graph.

40. The system of claim 38, wherein organizing the properties comprises receiving user input.

41. The system of claim 38, wherein the at least one organizing criterion comprises relevance data.

42. The system of claim 38, wherein the at least one organizing criterion comprises co-occurrence.

43. The system of claim 38, wherein storing the organized properties in a data structure comprises storing the organized properties in the knowledge graph.

44. The system of claim 38, wherein organizing the properties comprises ordering the properties based on relevance data.

45. The system of claim 38, wherein organizing the properties comprises ordering the properties based on a co-occurrence index.

46. The system of claim 38, wherein storing the organized properties in a data structure comprises storing organized properties and the associated type.

47. The system of claim 38, wherein storing the organized properties comprises storing a schema table.

48. A non-transitory computer-readable medium for use in search, the computer-readable medium having computer program instructions recorded thereon for:
traversing, using one or more computers, a knowledge graph to identify entity types, and to identify properties associated with each identified entity type;
for each identified entity type, organizing, using one or more computers, the properties associated with the respective entity type based on at least one organizing criterion into organized properties; and
storing, using one or more computers, the organized properties in a data structure that is usable to arrange search results based on the organized properties.

49. The non-transitory computer readable medium of claim 48, wherein traversing the knowledge graph comprises following linked nodes in the knowledge graph.

50. The non-transitory computer readable medium of claim 48, wherein organizing the properties comprises receiving user input.

51. The non-transitory computer readable medium of claim 48, wherein the at least one organizing criterion comprises relevance data.

52. The non-transitory computer readable medium of claim 48, wherein the at least one organizing criterion comprises co-occurrence.

53. The non-transitory computer readable medium of claim 48, wherein storing the organized properties in a data structure comprises storing the organized properties in the knowledge graph.

54. The non-transitory computer readable medium of claim 48, wherein organizing the properties comprises ordering the properties based on relevance data.

55. The non-transitory computer readable medium of claim 48, wherein organizing the properties comprises ordering the properties based on a co-occurrence index.

56. The non-transitory computer readable medium of claim 48, wherein storing the organized properties in a data structure comprises storing organized properties and the associated type.

57. The non-transitory computer readable medium of claim 48, wherein storing the organized properties comprises storing a schema table.
